(19) United States
(12) Patent Application Publication
(10) Pub. No.: US 2013/0144681 A1
(43) Pub. Date: Jun. 6, 2013

(54) COMPUTER-BASED METHOD FOR MANAGING CONFLICT IDENTIFICATION

(71) Applicant: Alina Quast, Redondo Beach, CA (US)

(72) Inventor: Alina Quast, Redondo Beach, CA (US)

(21) Appl. No.: 13/689,561

(22) Filed: Nov. 29, 2012

Related U.S. Application Data
(60) Provisional application No. 61/565,623, filed on Dec. 1, 2011.

(51) Int. Cl. G06Q 10/06

(52) U.S. Cl. CPC G06Q 10/0635
USPC 705/7.28

(57) ABSTRACT

The invention is a computer-based method for identifying and managing conflict identification within an organization. Specifically, the present invention preferably provides the organization with the ability to: (1) identify conflicts through preset factors; (2) designate trigger levels for each conflict; (3) identify the sources of each conflict; (4) provide email notifications of the identified conflict; (5) efficiently allocate existing resources by designating certain personnel to address the identified conflict; (6) suggest conflict intervention and de-escalation strategies to address the identified conflict; (7) provide a continuous feedback loop until the identified conflict is resolved; (8) provide users with a list of completed and pending assessments; and (9) provide a reporting scheme to track each conflict within the organization. Preferably, the present invention is adaptable and customizable to different organizational environments such as medical, business, military, and school administrative systems.

### CROSS-REFERENCE TO RELATED APPLICATIONS

Priority is claimed to U.S. Provisional Patent Application Ser. No. 61/565,623, filed on Dec. 1, 2011, titled “Method for Conflict Identification and Resolution,” the contents of which are expressly incorporated herein by this reference.

### FIELD OF INVENTION

This invention generally relates to computer-based methods for managing conflict identification. In particular, the invention relates to computer-based methods which provide conflict identification, prevention, de-escalation, and resolution of intra-organizational conflicts, client-related conflicts, and conflicts between the client and system.

### BACKGROUND

For decades, companies have utilized software applications to accomplish various tasks. Examples of such software include administrative and project management software that perform estimation and planning and accounting software that oversee cost control budget management. These software applications have been aiding companies and organizations by providing some outlook for planning certain projects.

Recently, however, software applications have been increasingly important to take into account intra-organizational conflicts, client-related conflicts, and conflicts between the client and system. These conflicts and disputes have been widely acknowledged, as they can negatively impact an organization in significant ways. For instance, intra-organizational conflicts (e.g., conflicts between the personnel in an organization) can reduce productivity, harm morale, and diminish an organization's stated goal of hiring and retaining the best qualified and most competent employees. Client-related conflicts and conflicts between the client and system (i.e., conflicts between a client and rule/procedure of the organization) can affect the quality of service provided by the organization and may cause an organization to lose business, harm the organization's reputation, and possibly subject the organization to malpractice claims.

While various software applications may be capable of addressing intra-organizational conflicts, client-related conflicts, and conflicts between the client and system, none exist to provide a mechanism for identifying such conflicts and disputes early on. Furthermore, none exist to provide an adequate response or strategy to address such conflicts. Without such software, intraorganizational conflicts continue to escalate, work-related stress increases, work morale lowers, quality of service diminishes, and quality of performance decreases. Additionally, the quality of service administered to a client diminishes, an organization may lose business, and the chances for malpractice liability will rise. These problems can easily be overcome by identifying and resolving the risk factors and conflict triggers early on.

In light of the foregoing, there is a need for a computer-based method and software application that provides conflict identification, prevention, de-escalation, and resolution in an intra-organizational and client setting.

### SUMMARY OF THE INVENTION

To minimize the limitations in the prior art, and to minimize other limitations that will become apparent upon reading and understanding the present specification, the present invention is system and computer-based method in managing conflict identification of intra-organizational conflicts, client-related conflicts, and conflicts between the client and system.

One embodiment of the invention is a computer-based method for managing conflict identification, the steps comprising: providing an electronic data processing unit and a server; wherein the electronic data processing unit provides one or more users with one or more assessments; inputting data into the one or more assessments by the one or more users to create one or more assessment data; populating a database of the server with the one or more assessment data; wherein the server includes one or more software applications; analyzing the one or more assessment data by the one or more software applications to identify one or more conflicts; and creating one or more alerts by the one or more software applications to notify one or more administrative users (or designated personnel/organizational users—i.e. those who are designated by the administrator to intervene) about the one or more conflicts. Preferably, the one or more assessment data includes one or more questions and one or more trigger levels. The analyzing step may further comprises the step of: comparing the one or more trigger levels of the one or more questions with one or more risk factors; wherein the one or more risk factors aid in recognizing the one or more conflicts. Preferably, the one or more software applications further comprises of: an administrative login; and a standard user login; wherein the administrative login typically provides the one or more administrative users with one or more administrative privileges; and wherein the standard user login typically provides the one or more users with one or more standard privileges. The one or more administrative privileges may be selected from the group consisting of: creating or editing one or more user accounts for the one or more users; creating or editing one or more questions of the one or more assessments; and accessing the one or more alerts. The one or more administrative privileges may also include creating or editing one or more question categories and creating or editing one or more conflict resolution/intervention actions. The one or more standard privileges may include performing the inputting step; and wherein the inputting step is performed by selecting one or more risk level selections for one or more questions of the one or more assessments. The one or more software applications may provide one or more conflict resolution actions to address the one or more conflicts. The computer-based method may further comprise the step of: providing one or more reports of the one or more conflicts by the one or more software applications. The analyzing step may further comprise the step of: analyzing one or more previous case histories to aid in identifying the one or more conflicts. The one or more assessments are preferably based upon the group consisting of: an intra-organizational subject; a client subject; and a forensic subject.

Another embodiment of the present invention is a computer-based method for managing conflict identification, the steps comprising: providing an electronic data processing unit and a server; wherein the electronic data processing unit provides one or more users with one or more assessments; inputting data into said one or more assessments by the one or more users to create one or more assessment data; populating a database of the server with the one or more assessment data; wherein the server includes one or more software applications; analyzing the one or more assessment data by the one or more software applications to identify one or more conflicts; and creating one or more alerts by the one or more software applications to notify one or more administrative users (or organizational users) about the one or more conflicts. Preferably, the one or more assessment data includes one or more questions and one or more trigger levels. Preferably, the analyzing step further comprises the step of: comparing the one or more trigger levels of the one or more questions with one or more risk factors; wherein the one or more risk factors preferably aid in recognizing the one or more conflicts. Preferably, the one or more software applications further comprises of: an administrative login; and a standard user login; wherein the administrative login typically provides the one or more administrative users with one or more administrative privileges; and wherein the standard user login typically provides the one or more users with one or more standard privileges. Preferably, the one or more standard privileges includes performing the inputting step; and wherein the inputting step is typically performed by selecting the one or more risk level selections for the one or more questions of the one or more assessments. The one or more software applications may provide one or more conflict resolution actions to address the one or more conflicts. The computer-based method may further comprise the step of: providing one or more reports of the one or more conflicts by the one or more software applications. The analyzing step may further comprise the step of: analyzing one or more previous case histories to aid in identifying the one or more conflicts. The one or more assessments are preferably based upon the group consisting of: an intra-organizational subject; a client subject; and a forensic subject.

Another embodiment of the present invention is a computer-based method for managing conflict identification, the steps comprising: providing an electronic data processing unit and a server; wherein the electronic data processing unit provides one or more users with one or more assessments; wherein the one or more assessments are based upon the group consisting of: an intra-organizational subject; a client subject; and a forensic subject; inputting data into the one or more assessments by the one or more users to create one or more assessment data; wherein the one or more assessment data includes one or more questions and one or more trigger levels; populating a database of the server with the one or more assessment data; wherein the server includes one or more software applications; wherein the one or more software applications further comprises of: an administrative login and a standard user login; wherein the administrative login provides the one or more administrative users with one or more administrative privileges; wherein the standard user login provides the one or more users with one or more standard privileges, such that the one or more users perform the inputting step by selecting the one or more risk level selections for the one or more questions of the one or more assessments; analyzing the one or more assessment data by the one or more software applications to identify one or more conflicts, such that the one or more software applications compare the one or more trigger levels of the one or more questions with one or more risk factors; wherein the one or more risk factors aid in recognizing the one or more conflicts; analyzing one or more previous case histories to aid in identifying the one or more conflicts; creating one or more alerts by the one or more software applications to notify one or more administrative users about the one or more conflicts; and providing one or more conflict resolution actions by the one or more software applications to address the one or more conflicts.

One object of this invention to provide a computer-based method that identifies, prevents, de-escalates, and resolves intra-organizational conflicts, client-related conflicts, and conflicts between the client and system.

Another object of this invention is to provide a computer-based method that can be customized to most environments such as the medical, business, military, and school administrative fields.

Another object of this invention is to provide a computer-based method that can: (1) provide early conflict identification according to predetermined conflict factors; (2) designate conflict trigger levels in order to prioritize organization designated conflicts; (3) identify the origin of the conflict (i.e., the source(s) of the identified conflict); (4) designate the personnel within the organization (customized to the organizational environment) who should address the identified conflict in order to better allocate existing resources; (5) alert designated resources, by email, of identified conflict; (6) suggest conflict intervention and de-escalation strategies that can be used to address the specific conflict; (7) provide a feedback loop until identified conflict trigger is resolved; (8) provide user access to list of completed and pending assessments; and (8) provide a reporting feature in order to track organizational conflict.

Another object of this invention is to provide a computer-based method that allows organizations to identify and prevent conflicts that may affect: (1) litigation related costs; (2) personnel loss/retainment/absence (e.g., hiring/retainment costs; use of sick days; Workman's Compensation claims); (3) stressful work environment; (4) poor morale/work stress; (5) the quality of service delivery; (6) the quality of performance within an organization; (7) comprehensive information regarding conflict risk factors; (8) the ease of access to valuable information; (9) the ease of identification of prevalent conflict triggers; (10) the facilitation of resource allocation/prioritization; and (11) quality of service provided to a client.

Another object of this invention is to provide an alert notification that identifies: (1) the subject of the conflict; (2) origin of conflict; (3) resources to dispatch; and (4) conflict resolution strategies/actions to utilize. Preferably, the alert will be sent at programmed intervals.

Another object of this invention is to identify and address intra-organizational conflicts, client-related conflicts, and conflicts between the client and system.

Another object of this invention is to allow for the electronic screening of an organization's client and personnel base for preventable conflicts which interfere with quality of care, quality of service, production, and performance.

Another object of this invention is to allow organizations to allocate valuable resources where they are most needed and most cost effective.

Another object of this invention is to allow organizations to electronically identify and track identified risk factors and generate reports that can be used for quality assurance and improvement of organizational activities.

It is an object of the present invention to overcome the limitations of the prior art.

Additional embodiments of the invention will be understood from the detailed description of the invention.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a block diagram of one embodiment of the computer-based method for managing conflict identification.

FIG. 2 is a screen shot of one embodiment of the computer-based method for managing conflict identification and shows the user lists page of the software application.

FIG. 3 is a screen shot of one embodiment of the computer-based method for managing conflict identification and shows the user account creation page of the software application.

FIG. 4 is a screen shot of one embodiment of the computer-based method for managing conflict identification and shows the user account creation page with a filter function.

FIG. 5 is a screen shot of one embodiment of the computer-based method for managing conflict identification and shows the roles list page of the software application.

FIG. 6 is a screen shot of one embodiment of the computer-based method for managing conflict identification and shows the department lists page of the software application.

FIG. 7 is a screen shot of one embodiment of the computer-based method for managing conflict identification and shows the question list page of the software application.

FIG. 8 is a screen shot of one embodiment of the computer-based method for managing conflict identification and shows the question category list page of the software application.

FIG. 9 is a screen shot of one embodiment of the computer-based method for managing conflict identification and shows the conflict origin list page of the software application.

FIG. 10 is a screen shot of one embodiment of the computer-based method for managing conflict identification and shows the action list page of the software application.

FIG. 11 is a screen shot of one embodiment of the computer-based method for managing conflict identification and shows the medical center list page of the software application.

FIG. 12 is a screen shot of one embodiment of the computer-based method for managing conflict identification and shows the region list page of the software application.

FIG. 13 is a screen shot of one embodiment of the computer-based method for managing conflict identification and shows the client list page of the software application.

FIG. 14 is a screen shot of one embodiment of the computer-based method for managing conflict identification and shows the client assessments page of the software application.

FIG. 15 is a screen shot of one embodiment of the computer-based method for managing conflict identification and shows reports page of the software application.

FIG. 16 is a screen shot of one embodiment of the computer-based method for managing conflict identification and shows the reports page with a graphical report.

FIG. 17 is a screen shot of one embodiment of the computer-based method for managing conflict identification and shows the page of the software application for starting a new assessment.

FIG. 18 is a screen shot of one embodiment of the computer-based method for managing conflict identification and shows the dashboard page of the software application.

FIG. 19 is a screen shot of one embodiment of the computer-based method for managing conflict identification and shows the client assessments page of the software application.

FIG. 20 is a screen shot of one embodiment of the computer-based method for managing conflict identification and shows the function for selecting different types of assessments.

FIG. 21 is a screen shot of one embodiment of the computer-based method for managing conflict identification and shows the create subject page of the software application when populating on an intra-organizational subject.

FIG. 22 is a screen shot of one embodiment of the computer-based method for managing conflict identification and shows the create subject page of the software application when populating on a client subject.

FIG. 23 is a screen shot of one embodiment of the computer-based method for managing conflict identification and shows the create subject page of the software application when populating on a forensic subject.

### DETAILED DESCRIPTION OF THE INVENTION

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. The term “conflict” refers to any problem, issue, discord, opposition, collision, incompatibility, or interference within an organization (i.e., intra-organizational conflicts), client-related conflicts, and conflicts between the client and system (e.g., conflicts between the client and rules/procedures of an organization) regarding the ideas, desires, events, activities, work-related functions, and quality assurance of the organization, including without limitation: problems affecting the quality of care/service; issues relating to litigation related costs; problems relating to clients of an organization; problems relating to an organization's personnel loss/retainment/absence such as hiring/retainment costs, use of sick days, Workman's Compensation claims; problems arising from a stressful work environment; problems relating to poor morale/work stress; problems relating to the quality of service delivery; issues affecting the quality of performance within an organization; issues affecting comprehensive information regarding conflict risk factors; problems involving the accessibility to valuable information; problems relating to the identification of conflict triggers; and problems relating to the facilitation of resource allocation/prioritization.

The term “conflict resolution action” refers to any process, activity, procedural response, dispute resolution action, or intervention action introduced to the administrative user by the software application to address the risks or conflicts within an organization in order to prevent, de-escalate, and/or resolve further issues of the organization, including without limitation, assigning an advocate, constructing an agreement, educating a staff, evaluating adherence to negotiated agreement, evaluate morale, evaluate provider functioning, evaluate provider satisfaction, evaluate subject compliance, evaluate subject coping skills, evaluate subject satisfaction, designating certain trigger levels or minimum requirements for each conflict, identifying the source(s) for each conflict, designating certain personnel within an organization to address each conflict, providing a strategy to address each conflict, providing continuous feedback until the conflict is resolved, providing a list of one or more resolved conflicts, providing a list of one or more pending conflicts, and providing a reporting scheme to track the one or more conflicts.

The terms “computer” and “electronic data processing unit” refer to any device that processes information with an integrated circuit chip, including without limitation, mainframe computers, work stations, servers, desktop computers, portable computers, laptop computers, embedded computers, wireless devices including cellular phones, tablet computers, personal digital assistants, digital media players, portable game players, and hand-held computers.

The term “administrative user” preferably refers to any manager, designated personnel, or organizational user (i.e. those who are designated by the administrator to intervene) that reviews information relating to assessment data and retains one or more administrative privileges. The term “user” preferably refers to any member that belongs to an organization and is typically limited to one or more standard privileges.

The term “administrative privilege” refers to the highest level of permission that is granted to a computer user, including without limitation, creating additional user profiles and email addresses; activating and deactivating user profiles; assigning trigger level preferences or minimum requirements for specified risk factors/questions; creating and designating categories for each conflict source/origin through the use of specific questions; creating and designating conflict resolution/de-escalation actions/strategies; designating trigger levels; designating the threshold of trigger levels, designating resource allocation for certain conflicts; designating alert notifications to certain recipients; designating alert responses to certain recipients; customizing time intervals for each alert notifications; creating departmental reports, question reports, question category reports, reports relating to business locations, reports relating to regions, and time interval reports; and populating or supplying information in an electronic data processing unit regarding the roles of: (i) each personnel within an organization; (ii) the departments within an organization; (iii) the subject matter within an organization; (iv) assessment questions; (v) categories of assessment questions; (vi) business locations of an organization; and (vii) the regions within an organization.

The term “standard privilege” refers to the common level of permission that is granted to a computer user, including without limitation, creating/generating an assessment of an organization by answering a questionnaire in an electronic data processing unit; choosing the subject matter of the assessment; rating/answering each question of an assessment based upon a scale or spectrum (e.g., using a 0-5 scale; wherein 0=no risk factor and 5=severe risk factor); saving partially completed assessments; resuming partially completed assessments; and saving, resuming, and submitting completed assessments.

Furthermore, the term “previous case history” preferably refers to any information deriving from a former client, former employee, former entity, or third party. The term “intra-organizational subjects” preferably refers to matters specific to an organization including, without limitation, roles, departments, and the like. The term “client” preferably refers to matters or traits that are specific to an individual including, without limitation, ethnicity, gender, date of birth, and the like. The term “forensic subjects” preferably refers to information and matters that are specific to former employees or former clients including, without limitation, case identification number, service dates, provider information, claim information, medical center information, region information, and the like. The term “risk factor” is preferably any variable associated with an increased risk of chances that a particular conflict or event will occur.

The software application of the electronic data processing unit proposed by the present invention preferably provides organizations with one or more early conflict trigger identification methods through the use of analyzing assessment data from clients and/or personnel of an organization as well as files from former clients and former employees. Such information obtained from the software application will preferably: (1) facilitate customization of the software's early conflict identification triggers for each client assessment; (2) facilitate customization of the software's early conflict identification triggers for the intra-organizational and client-related assessments; (3) facility analysis of conflict triggers in specified business locations and regions; (4) facilitate analysis of conflict occurrence and prevalence for specific users within the organization; and (5) analyze an organization's legal claims for predetermined conflict triggers. As such, the software application preferably aids organizations in early conflict identification, intervention, and prevention for intra-organizational conflicts, client-related conflicts, and conflicts between the client and system.

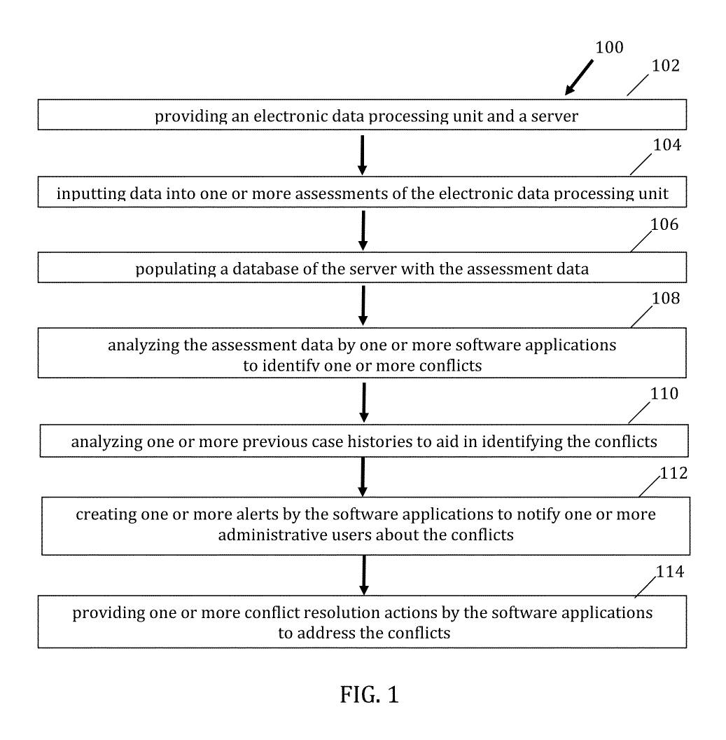

FIG. 1 is a block diagram of one embodiment of the computer-based method for managing conflict identification. As shown in FIG. 1, the computer-based method 100 preferably includes the steps of: providing an electronic data processing unit and a server 102; inputting data into one or more assessments of the electronic data processing unit 104; populating a database of the server with the assessment data 106; analyzing the assessment data by one or more software applications to identify one or more conflicts 108; analyzing one or more previous case histories to aid in identifying the conflicts 110; creating one or more alerts by the software applications to notify one or more administrative users about the conflicts 112; and providing one or more conflict resolution actions by the software applications to address the conflicts 114.

FIG. 1 shows the first step of one embodiment of the computer-based 100, which is to provide an electronic data processing unit and a server 102. An electronic data processing unit is typically any general purpose device that carries out a finite set of arithmetic or logical operations. The electronic data processing unit typically comprises of a bus, processor, memory, mass storage device, and other input/output devices and may also include one or more displays, a keyboard or keypad, and a pointing device. The electronic data processing unit may also include other components without deviating from the scope of the invention. Preferably, the electronic data processing unit is a personal computer desktop or laptop, but may be any type of computing device such as a tablet, mobile/cellular phone, or the like.

The server is preferably a hardware configuration with a central processing unit with one or more software applications configured to analyze assessment data sent by the electronic data processing units. Additionally, the server is preferably configured to generate reports, alerts, and/or notifications of conflicts that will preferably be sent to the administrative user or designated personnel.

The software application may include an administrative login and a standard user login. The administrative login preferably provides administrative users or designated personnel with one or more administrative privileges while the standard user login preferably provides users with standard privileges. As discussed above, an administrative privilege refers to a high level of permission that is granted to a computer user, which typically includes creating user accounts/user profiles; creating/categorizing questions; and accessing alerts or notifications. However, an administrative privilege may include other privileges as well. The standard privilege refers to the common level of permission that is granted to a user, which typically includes completing assessments and rating/answering each question of an assessment based upon a scale or spectrum (e.g., using a 0-5 scale; wherein 0=no risk factor and 6=severe risk factor). However, like administrative privileges, standard privileges may also include other privileges as well.

Preferably, the electronic data processing unit provides users with assessments to determine whether a conflict exists, and the user is typically invited to answer the assessments. The assessments are preferably surveys, observations, or evaluations regarding certain factors within an organization and are preferably geared into identifying potential conflicts. Additionally, the assessments may be based upon an intra-organizational subjects (e.g., based upon departments or roles within the organization), client subjects (e.g., based upon gender and/or ethnicity of a client) and/or forensic subjects (e.g. based upon former employees and former clients).

FIG. 1 also shows the second step of one embodiment of the computer-based method 100, which is inputting data into one or more assessments of the electronic data processing unit 104. The assessments, which are preferably surveys, observations, or evaluations, preferably include one or more questions relating to certain topics. The assessments also may group certain questions into categories to designate certain questions with certain users. Each question preferably includes a corresponding set of answers, which are preferably trigger levels that rate the risk factor on a certain topic. For instance, one or more questions may include the following trigger levels: “0”=no risk; “1”=minimal risk; “2”=average risk; “3”=moderate risk; “4”=high risk; and “5”=critical but may use any scale such as “0” to “3”; “0” to “4”; or “0” to “6”. Once the user answers one or more questions, assessment data is generated and typically comprises of information such as: (1) question type; (2) trigger levels; and (3) user data. However, assessment data may include other data such as information pertaining to the organization's departments, regions, and roles.

FIG. 1 shows the third and fourth step of the computer based method 100—i.e., populating a database of the server with the assessment data 106 and analyzing the assessment data by one or more software applications to identify one or more conflicts 108. After the assessment is completed and submitted, the assessment data is preferably sent to the server via a network and is preferably filled or populated into a database of the server. Once populated, the assessment data is preferably analyzed by the software application in order to determine whether conflicts are present. This is preferably achieved by comparing the trigger levels submitted by the users and attributing the trigger levels with certain risk factors (i.e., variables associated within the organization that indicates an increased risk that a particular conflict or event will occur). Other various methods and algorithms may also be used to identify potential conflicts. For instance, an organization may emphasize certain risk factors by focusing on certain trigger levels to determine whether a high risk is present. Similarly, the organization may also deemphasize certain risk factors by increasing the trigger level threshold on other types or question categories (e.g., a risk level selection such as “5” preferably indicates that the trigger level must be at the highest level to occur, whereas a low pre-designated risk level selection such as “1” indicates that the conflict resolution action needs to occur even when a minor event occurs).

FIG. 1 also shows the fifth step of one embodiment of the computer-based method 100, which is analyzing one or more previous case histories to aid in identifying the conflicts 110. Like the previous step, the software applications may also analyze previous case histories (e.g., file information of a former employee, former client, or third party) to identify other potential conflicts within an organization. Specifically, the computer-based method 100 preferably analyzes the trigger levels submitted by a former employee or former client and compare the trigger levels with the risk factors configured by an organization. The computer-based method 100 may also utilize other methods and algorithms to review and analyze information pertaining to previous case histories.

FIG. 1 shows the sixth and seventh step of one embodiment of the computer based method 100—i.e., creating one or more alerts by the software applications to notify one or more administrative users about the conflicts 112 and providing one or more conflict resolution actions by the software applications to address the conflicts 114. After identifying conflicts within an organization, the software application may generate alerts to administrative users or designated personnel to notify them about certain conflicts. This is commonly achieved by including a notification in an administrative user's dashboard (i.e., home page of a user's account) or by sending an email to the administrative user. However, an alert or notification may be sent to the administrative user or designated personnel in other ways such as text message, voice mail, physical mail, verbal communication, or the like.

After sending an alert or notification, the software application of the computer-based method 100 preferably provides one or more conflict resolution actions, to assist in preventing or deescalating the one or more conflicts. For example, the computer-based method 100 may inform the administrative user to: (1) assign an advocate to the user; (2) construct an agreement with the user; or (3) educate the staff. However, the computer-based method 100 may include other conflict resolution actions as well. Further, the software application may also provide other information regarding the conflict resolution actions such as the origin of the conflict, department or region where the conflict arose, or name of client. Once informed, the administrative user may address, prevent, and deescalate potential conflicts within the organization.

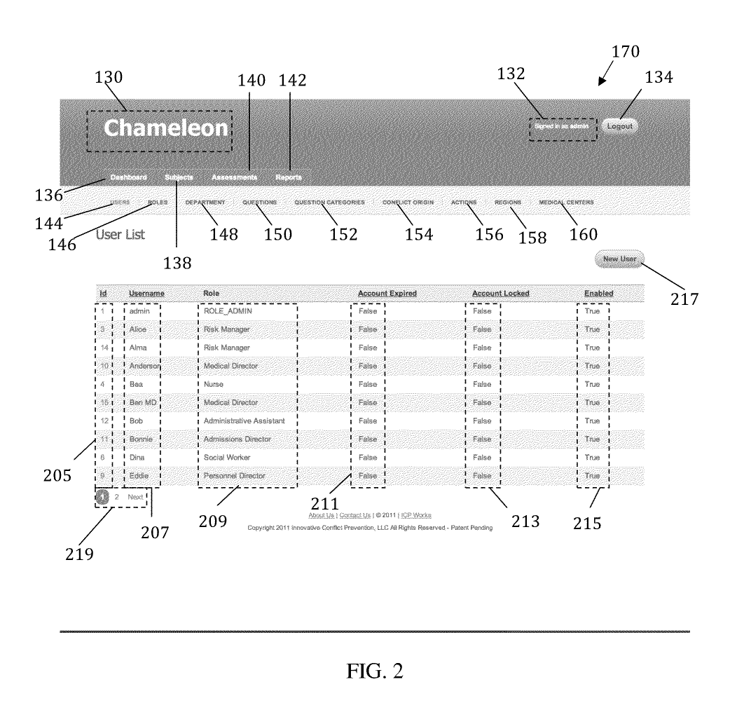

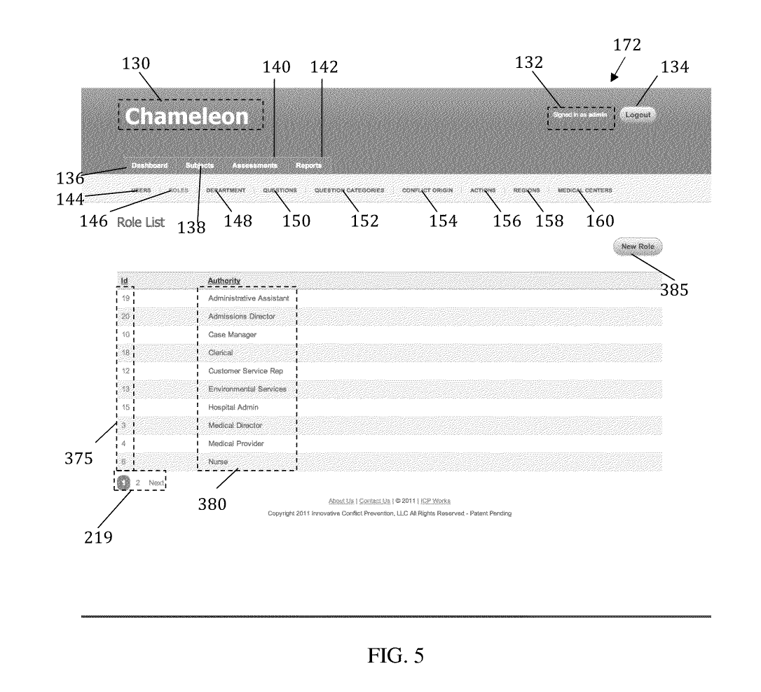

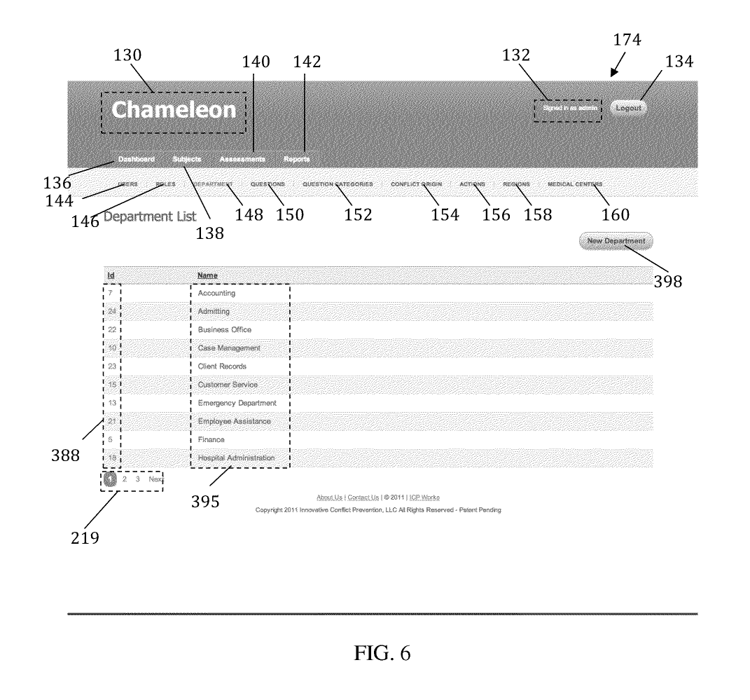

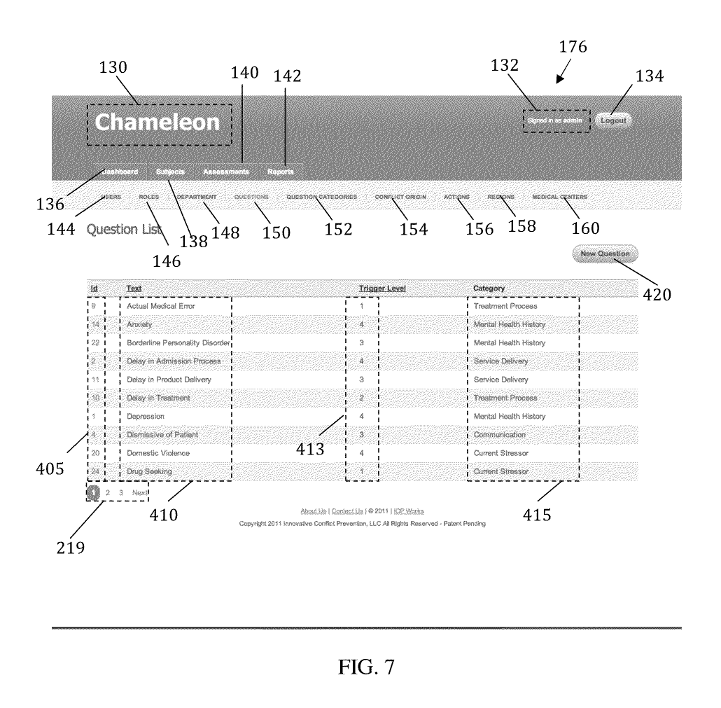

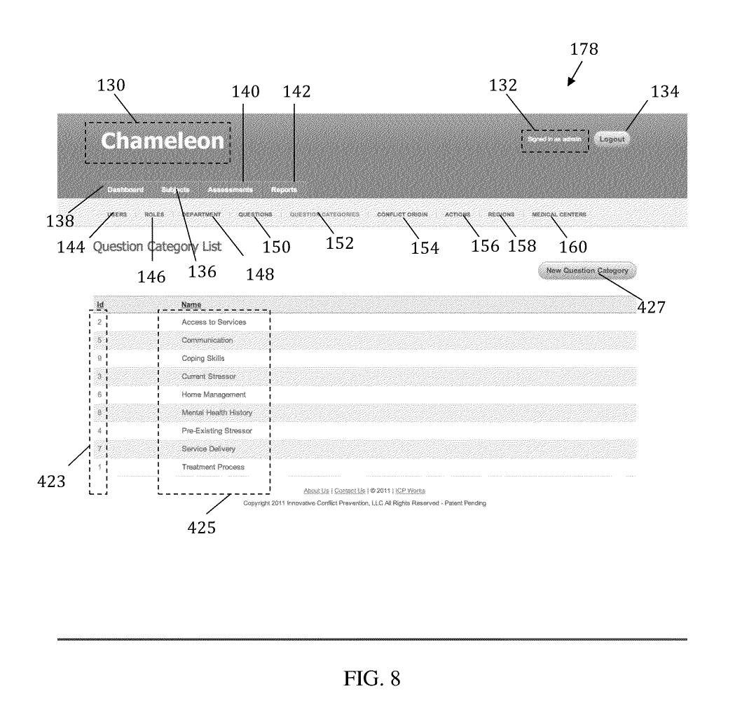

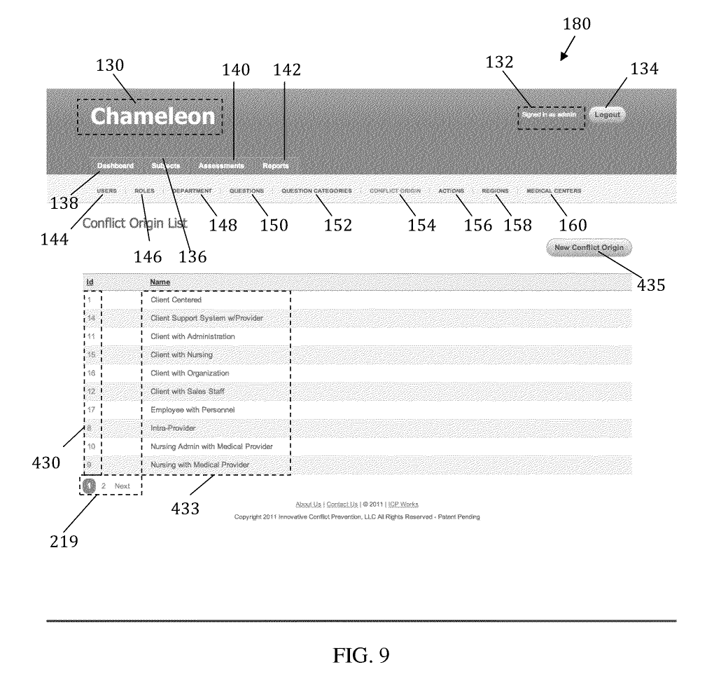

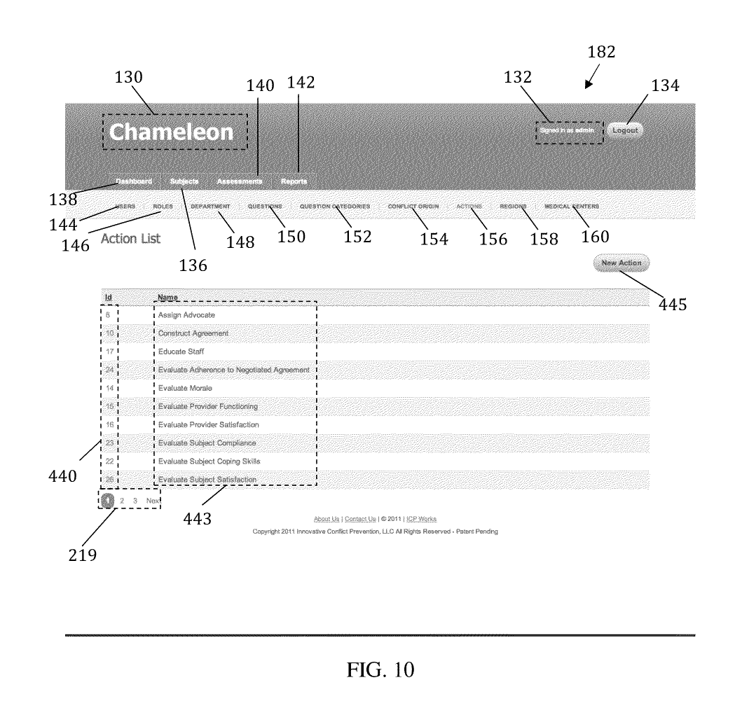

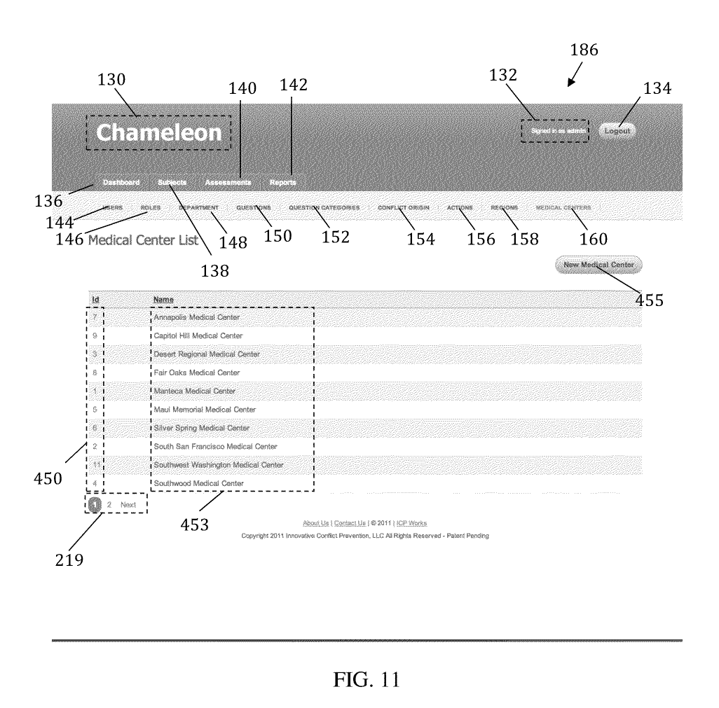

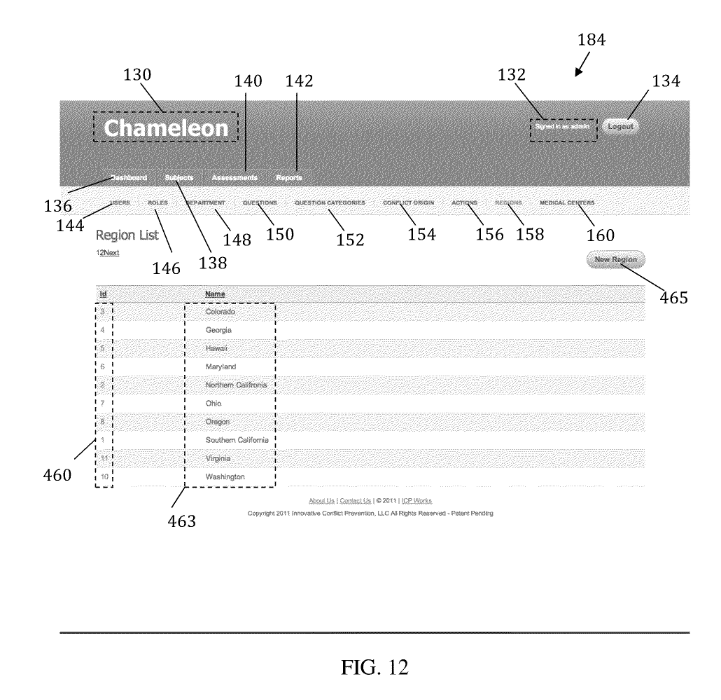

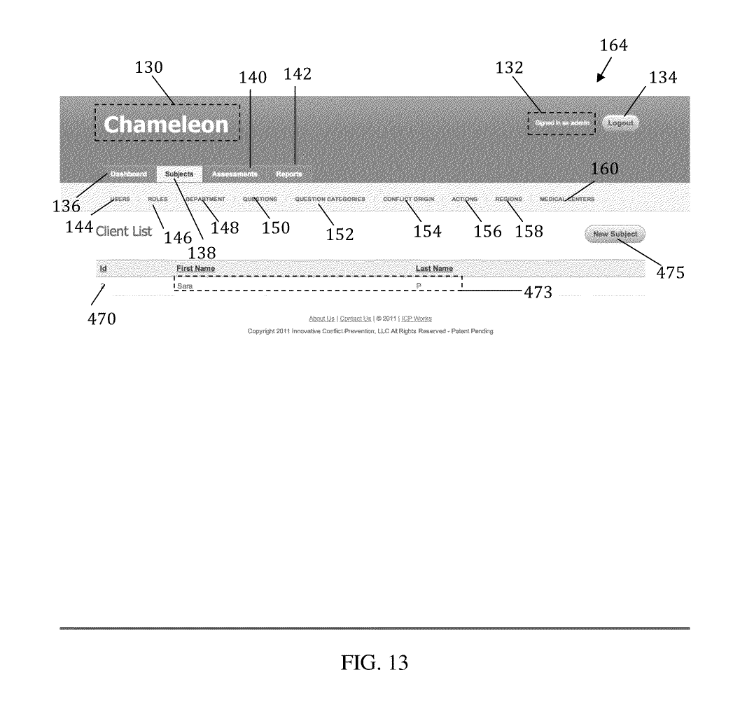

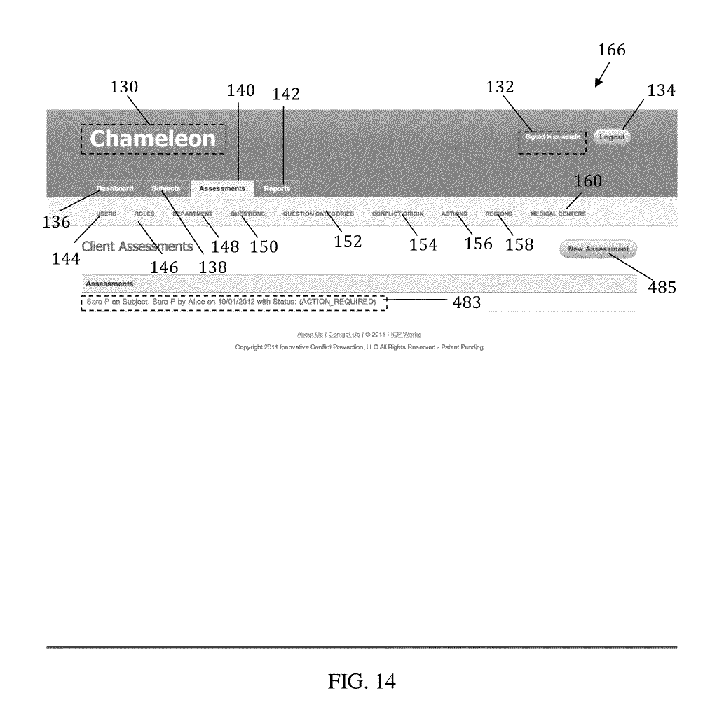

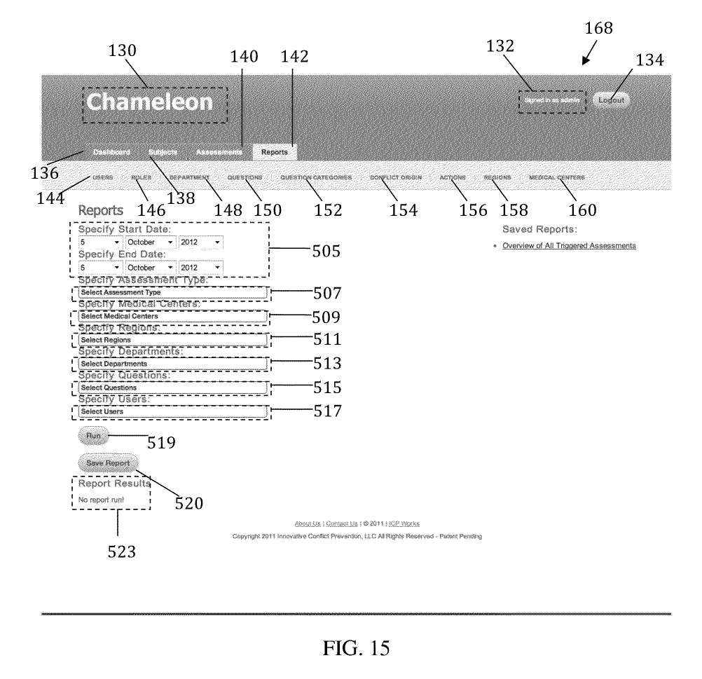

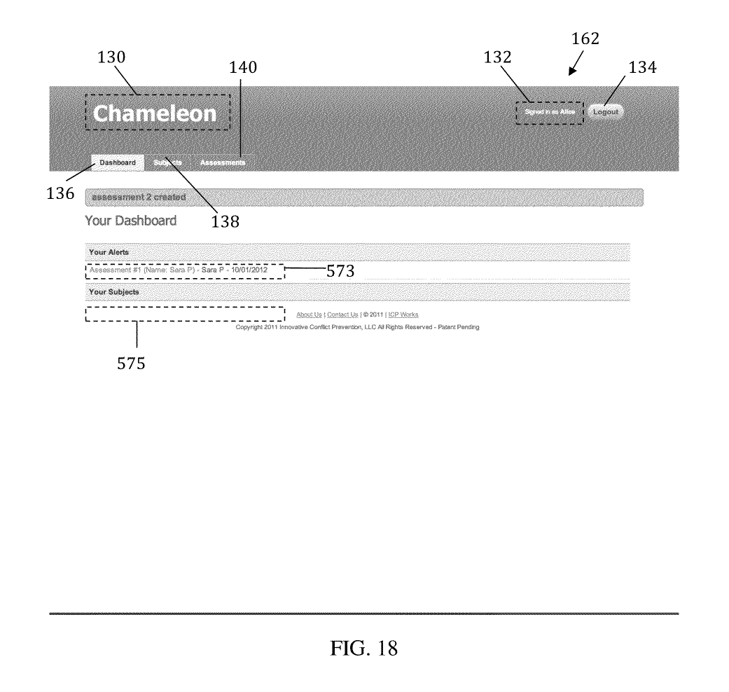

FIG. 2 is a screen shot of one embodiment of the computer-based method for managing conflict identification and shows the user lists page of the software application. As shown in FIG. 2, the user lists page 170 of the computer-based method 100 preferably includes: a logo 130; login status 132; logout button 134; dashboard button 136; subjects button 138; assessment button 140; reports button 142; users list button 144; roles button 146; department button 148; questions button 150; questions categories button 152; conflict origin button 154; actions button 156; regions button 158; medical centers button 160; and page selects 219. The logo 130 preferably identifies the name of the software application and/or company. The login status 132 preferably identifies whether the user is signed into the system and may identify whether the user is a standard user or administrative user. The logout button 142 preferably provides the option to logout or sign out of the user account session. The dashboard button 136 preferably provides access to the dashboard page 162 (shown in FIG. 18), which typically provides the administrative user or user with information regarding alerts and subjects. The subjects button 138 preferably provides access to the client list page 164 (shown in FIG. 13), which typically includes information regarding certain users or clients subject to assessment and may provide the option for creating, adding, or editing a new subject. The assessment button 140 preferably provides access to the client assessments page 166 (shown in FIG. 14), which typically provides information regarding assessments and may include the option to create, add, or edit a new assessment. The reports button 142 preferably provides access to the reports page 168 (shown in FIG. 15), which typically includes general information about certain reports and may search for reports using options and filters. The user lists button 144 preferably provides access to the user list page 170, which typically includes a comprehensive list of all the users and corresponding account information for each user. The roles button 146 preferably provides access to the roles list page 172 (shown in FIG. 5), which typically includes a list of the applicable roles and may include the option of creating, adding, or editing a new role. The department button 148 preferably provides access to the department list page 174 (shown in FIG. 6), which typically includes a list of the different departments of the organization and may include the option of creating, adding, or editing a new department. The question button 150 preferably provides access to the question list page 176 (shown in FIG. 7), which typically includes a list of the different questions and corresponding information (e.g., text, trigger level, and category of each question) and may include the option of creating, adding, or editing a new question. The questions category button 152 preferably provides access to the question category list page 178 (shown in FIG. 8), which typically includes a list of the applicable categories of each question and may include the option to create, add, or edit a new question category. The conflict origin button 154 preferably provides access to the conflict origin list page 180 (shown in FIG. 9), which typically includes a list of the conflict origins and may include the option to create, add, or edit a new conflict origin. The actions button 156 preferably provides access to the action list page 182 (shown in FIG. 10), which typically includes a list of all the applicable actions governed by the computer-based method 100 and may include the option to create, add, or edit a new action. The regions button 158 preferably provide access to the region list page 184 (shown in FIG. 12), which typically includes a list of all the regions applicable to the computer-based method 100 and may include the option to create, add, or edit a new region. The medical centers button 160 preferably provides access to the medical center list page 186 (shown in FIG. 11), which preferably includes a list of the medical centers applicable to the computer based method 100 and may include the option to create, add, or edit a new medical center. The page selects 219 preferably allow the user or administrator to switch between pages if the information extends beyond a single page.

FIG. 2 also shows that the user lists page 170 preferably includes: a plurality of identification numbers 205, plurality of usernames 207, plurality of roles 209, account expiration status 211, account lock status 213, account enabled status 215, and new user button 217. The plurality of identification numbers 205 are preferably one or more alphanumeric characters that are assigned to each username, as applied to the organization. The plurality of usernames 207 is preferably one or more names of users subject to the computer-based method 100. The plurality of roles 209 is preferably one or more roles assigned to each user and is typically job titles of the user. The account expiration status 211 preferably shows whether the account is expired. The account lock status 213 preferably shows whether the account is locked. The account enabled status 215 preferably shows whether the account is currently in use. Although FIG. 2 shows that the account expiration status 211, account lock status 213, and account enabled status 215 are expressed in “True” or “False” logic operators, these status indicators may be express in other ways such as “Yes”/“No”; “Y”/“N”; or the like. Furthermore, the new user button 217 preferably allows the administrator to create a new user for the computer-based method 100.

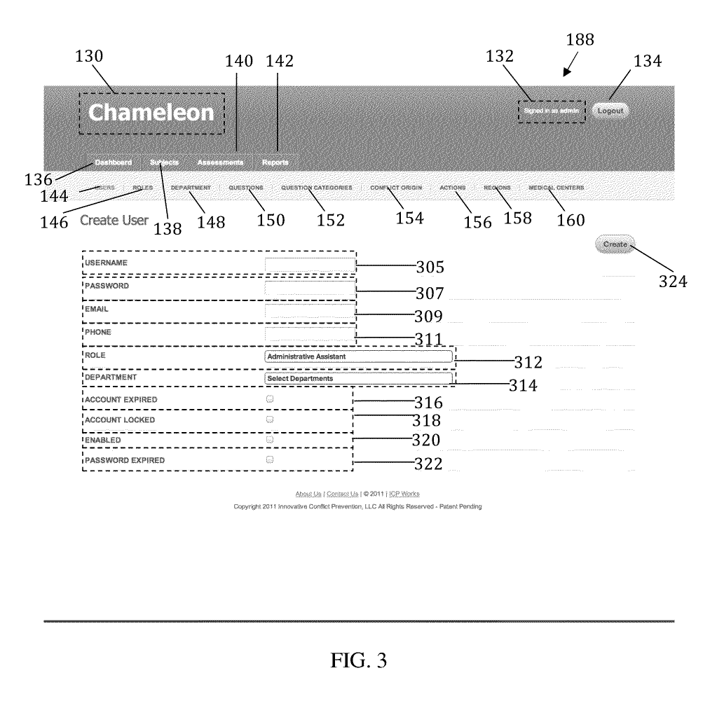

FIG. 3 is a screen shot of one embodiment of the computer-based method for managing conflict identification and shows the user account creation page of the software application. As shown in FIG. 3, the user account creation page 188 of the computer-based method 100 preferably includes: a logo 130; login status 132; logout button 134; dashboard button 136; subjects button 138; assessment button 140; reports button 142; users list button 144; roles button 146; department button 148; questions button 150; questions categories button 152; conflict origin button 154; actions button 156; regions button 158; and medical centers button 160. The user account creation page 188 also preferably includes: a username input field 305; password input field 307; email input field 309; phone number input field 311; role selection field 312; department selection field 314; account expiration checkbox 316; account locked checkbox 318; account enabled checkbox 320; password expiration checkbox 322; and create button 324.

Upon selecting the new user button 217, the user account creation page 188 preferably allows the administrative user to create a new user account. This typically involves: (1) inputting a new user name into the username input field 305; (2) inputting a new password in the password input field 307; (3) inputting new email information into the email input field 309; and/or (4) inputting a new phone number into the phone number input field 311. A new role, which is typically the job description of the user, is also generally assigned to the user and is typically selected from multiple roles available in the role selection field 313. The relevant department may also be assigned to the new user by selecting the applicable department from the department selection field 314. Furthermore, pertinent user account information may also be applied by selecting any of the following: account expiration checkbox 316; account locked checkbox 318; account enabled checkbox 320; and/or password expiration checkbox 322.

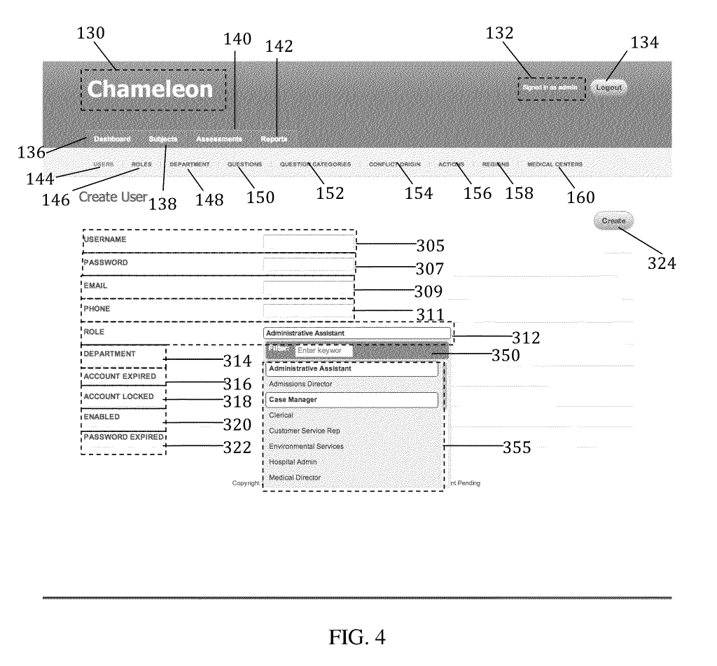

FIG. 4 is a screen shot of one embodiment of the computer-based method for managing conflict identification and shows the user account creation page with a filter function. As shown in FIG. 4, the user account creation page 188 of computer-based method 100 preferably includes: a logo 130; login status 132; logout button 134; dashboard button 136; subjects button 138; assessment button 140; reports button 142; roles button 146; department button 148; questions button 150; questions categories button 152; conflict origin button 154; actions button 156; regions button 158; and medical centers button 160. The user account creation page 188 also preferably includes: a username input field 305; password input field 307; email input field 309; phone number input field 311; role selection 312; department selection 314; account expiration checkbox 316; account locked checkbox 318; account enabled checkbox 320; password expiration checkbox 322; create button 324; filter function 350; and plurality of roles 355. Preferably, upon selecting any menu function (e.g., selecting a specified role, as shown in FIG. 4), the administrative user may filter certain information by utilizing the filter function 350, which allows the administrative user to input one or more alphanumeric characters to reduce the search results for a particular selection.

FIG. 5 is a screen shot of one embodiment of the computer-based method for managing conflict identification and shows the roles list page of the software application. As shown in FIG. 5, the roles list page 172 of the computer-based method 100 preferably includes: a logo 130; login status 132; logout button 134; dashboard button 136; subjects button 138; assessment button 140; reports button 142; users list button 144; roles button 146; department button 148; questions button 150; questions categories button 152; conflict origin button 154; actions button 156; regions button 158; medical centers button 160; and page selects 219. The roles list page 172 also preferably includes: a plurality of identification numbers 375; plurality of roles 380; and new role button 385. The plurality of identification numbers 375 are preferably numbers assigned to each role, as applied to the organization. The plurality of roles 380 is preferably one or more roles or job titles that may be applicable to a particular user. For example, FIG. 5 shows that the computer-based method 100 may include roles such as: administrative assistant, admissions director, case manager, clerical, customer service representative, environmental services, hospital administrator, medical director, medical provider, and nurse. However, other additional roles may be added by the administrative user, and may be added by selecting the new role button 385.

FIG. 6 is a screen shot of one embodiment of the computer-based method for managing conflict identification and shows the department lists page of the software application. As shown in FIG. 6, the department lists page 174 of the computer-based method 100 preferably includes: a logo 130; login status 132; logout button 134; dashboard button 136; subjects button 138; assessment button 140; reports button 142; users list button 144; roles button 146; department button 148; questions button 150; questions categories button 152; conflict origin button 154; actions button 156; regions button 158; medical centers button 160; and page selects 219. The department lists page 174 also preferably includes: a plurality of identification numbers 388; plurality of departments 395; and new department button 398. The plurality of identification numbers 388 are preferably numbers assigned to each department, as applied to the organization. The plurality of departments 395 is preferably one or more departments that may be applicable to one or more users. For example, FIG. 6 shows that the computer-based method 100 may include departments such as: accounting, admitting, business office, case management, client records, customer service, emergency department, employee assistance, finance, and hospital administration. However, other departments may be added by the administrative user, and may be added by selecting the new department button 398.

FIG. 7 is a screen shot of one embodiment of the computer-based method for managing conflict identification and shows the question list page of the software application. As shown in FIG. 7, the question list page 176 of the computer-based method 100 preferably includes: a logo 130; login status 132; logout button 134; dashboard button 136; subjects button 138; assessment button 140; reports button 142; users list button 144; roles button 146; department button 148; questions button 150; questions categories button 152; conflict origin button 154; actions button 156; regions button 158; medical centers button 160; and page selects 219. The question list page 176 also preferably includes: a plurality of identification numbers 405; plurality of questions 410; plurality of trigger levels 413; a plurality of categories 415; and new question button 420. The plurality of identification numbers 405 are preferably one or more alphanumeric characters assigned to each question. The plurality of questions 395 is preferably one or more questions designated for each assessment. For example, as shown in FIG. 7, the plurality of questions 410 may include: actual medical error, anxiety, borderline personality disorder, delay in admission process, delay in product delivery, delay in treatment, depression, dismissive of patient, domestic violence, and drug seeking. However, other additional questions may be added by the administrative user, and may be added by selecting the new question button 420. The plurality of trigger levels 413 generally indicate the applicable trigger level for each question submitted by a user in an assessment, and may be expressed in a numerical fashion to indicate the degree of importance. The plurality of categories 415 is preferably one or more categories assigned to each particular question and may include categories such as: treatment process, mental health history, service delivery, communication, and current stressor. However, any other types of categories may be used or added by the administrative user.

FIG. 8 is a screen shot of one embodiment of the computer-based method for managing conflict identification and shows the question category list page of the software application. As shown in FIG. 8, the question category list page 178 of the computer-based method 100 preferably includes: a logo 130; login status 132; logout button 134; dashboard button 136; subjects button 138; assessment button 140; reports button 142; users list button 144; roles button 146; department button 148; questions button 150; questions categories button 152; conflict origin button 154; actions button 156; regions button 158; medical centers button 160; and page selects 219. The question category list page 178 also preferably includes: a plurality of identification numbers 423; plurality of question category 425; and new question category button 427. The plurality of identification numbers 405 are preferably one or more alphanumeric characters assigned to each question category. The plurality of questions 395 is preferably one or more questions utilized for each assessment. For example, FIG. 8 shows that the computer-based method 100 may include question categories 425 such as: access to services, communication, coping skills, current stressor, home management, mental health history, pre-existing stressor, service delivery, and treatment process. However, other question categories may be added by the administrative user, and may be added by selecting the new question category button 427.

FIG. 9 is a screen shot of one embodiment of the computer-based method for managing conflict identification and shows the conflict origin list page of the software application. As shown in FIG. 9, the conflict origin list page 180 of the computer-based method 100 preferably includes: a logo 130; login status 132; logout button 134; dashboard button 136; subjects button 138; assessment button 140; reports button 142; users list button 144; roles button 146; department button 148; questions button 150; questions categories button 152; conflict origin button 154; actions button 156; regions button 158; medical centers button 160; and page selects 219. The conflict origin list page 180 also preferably includes: a plurality of identification numbers 430; plurality of conflicts 433; and new conflict button 435. The plurality of identification numbers 430 are preferably one or more alphanumeric characters assigned to each conflict origin, as applied to the organization. The plurality of conflicts 433 is preferably one or more sources of conflicts or conflict origins that may be based upon an assessment and may be assigned to each particular question. For example, FIG. 9 shows that the computer-based method 100 may include conflict origins such as: client centered, client support system with provider, client with administration, client with nursing, client with organization, client with sales staff, employee with personnel, intra-provider, nursing administrator with medical provider, and nursing with medical provider. However, other conflict origins may be added by the administrative user, and may be added by selecting the new conflict origin button 435.

FIG. 10 is a screen shot of one embodiment of the computer-based method for managing conflict identification and shows the action list page of the software application. The action list page 182 preferably provides the administrative user with a list of actions (i.e., conflict resolution actions) to address one or more conflicts. As shown in FIG. 10, the action list page 182 of the computer-based method 100 preferably includes: a logo 130; login status 132; logout button 134; dashboard button 136; subjects button 138; assessment button 140; reports button 142; users list button 144; roles button 146; department button 148; questions button 150; questions categories button 152; conflict origin button 154; actions button 156; regions button 158; medical centers button 160; and page selects 219. The action list page 182 also preferably includes: a plurality of identification numbers 440; plurality of actions 443; and new action button 445. The plurality of identification numbers 440 are preferably one or more alphanumeric characters assigned to each action, as applied to the organization. The plurality of actions 443 is preferably one or more actions that may be used to assist in resolving or preventing each conflict or potential conflict, and are typically based upon the trigger level(s) of each question and assessment. For example, FIG. 10 shows that the computer-based method 100 may include actions such as: assign advocate, construct agreement, educate staff, evaluate adherence to negotiated agreement, evaluate morale, evaluate provider functioning, evaluate provider satisfaction, evaluate subject compliance, evaluate subject coping skills, and evaluate subject satisfaction. However, other actions may be added by the administrative user and may be added by selecting the new action button 445.

FIG. 11 is a screen shot of one embodiment of the computer-based method for managing conflict identification and shows the medical center list page of the software application. As shown in FIG. 11, the medical center list page 186 of the computer-based method 100 preferably includes: a logo 130; login status 132; logout button 134; dashboard button 136; subjects button 138; assessment button 140; reports button 142; users list button 144; roles button 146; department button 148; questions button 150; questions categories button 152; conflict origin button 154; actions button 156; regions button 158; medical centers button 160; and page selects 219. The medical center list page 186 also preferably includes: a plurality of identification numbers 450; plurality of medical centers 453; and new medical center button 455. The plurality of identification numbers 450 are preferably one or more alphanumeric characters assigned to each medical center, as applied to the organization. The plurality of medical centers 453 is preferably one or more medical centers used for the computer-based method 100, as applied to inter-organizational, intra-organizational settings, and client-related settings. The new medical center button 445 preferably allows the administrative user to add a new medical center for the computer-based method 100. Although FIG. 11 shows a list of medical centers, it should be understood that the present invention also applies to any type of business or organization.

FIG. 12 is a screen shot of one embodiment of the computer-based method for managing conflict identification and shows the region list page of the software application. As shown in FIG. 12, the region list page 184 of the computer-based method 100 preferably includes: a logo 130; login status 132; logout button 134; dashboard button 136; subjects button 138; assessment button 140; reports button 142; users list button 144; roles button 146; department button 148; questions button 150; questions categories button 152; conflict origin button 154; actions button 156; regions button 158; and medical centers button 160. The region list page 184 also preferably includes: a plurality of identification numbers 460; plurality of regions 463; and new region button 465. The plurality of identification numbers 460 are preferably one or more alphanumeric characters assigned to each region, as applied to the organization. The plurality of regions 463 is preferably one or more regions used for the computer-based method 100, as applied to inter-organizational and intra-organizational settings. For example, FIG. 12 shows that the computer-based method 100 may include regions such as: Colorado, Georgia, Hawaii, Maryland, Northern California, Ohio, Oregon, Southern California, Virginia, and Washington. However, other regions may be added by the administrative user, and may be added by selecting the new region button 445.

FIG. 13 is a screen shot of one embodiment of the computer-based method for managing conflict identification and shows the client list page of the software application. As shown in FIG. 13, the client list page 164 of the computer-based method 100 preferably includes: a logo 130; login status 132; logout button 134; dashboard button 136; subjects button 138; assessment button 140; reports button 142; users list button 144; roles button 146; department button 148; questions button 150; questions categories button 152; conflict origin button 154; actions button 156; regions button 158; and medical centers button 160. The client list page 164 also preferably includes: one or more of identification numbers 470; one or more client names 473; and new subject button 465. The one or more identification numbers 470 are preferably one or more alphanumeric characters assigned to each client. The one or more client names 473 is preferably one or more clients used for the computer-based method 100, as applied to inter-organizational, intra-organizational settings, and client-related matters. The new subject button 475 preferably allows the administrative user to add or create a new client to the computer-based method 100.

FIG. 14 is a screen shot of one embodiment of the computer-based method for managing conflict identification and shows the client assessments page of the software application. As shown in FIG. 14, the client assessments page 166 of the computer-based method 100 preferably includes: a logo 130; login status 132; logout button 134; dashboard button 136; subjects button 138; assessment button 140; reports button 142; users list button 144; roles button 146; department button 148; questions button 150; questions categories button 152; conflict origin button 154; actions button 156; regions button 158; and medical centers button 160. The client assessments page 166 also preferably includes: one or more assessments 473; and new assessment button 475. The assessment 473 is preferably one or more set of questions completed by a user and preferably indicates desired trigger level. The assessment 473 also may include other information such as whether any action is required. Further, the new assessment button 475 preferably allows the administrative user to add a new assessment to the computer-based method 100.

FIG. 15 is a screen shot of one embodiment of the computer-based method for managing conflict identification and shows reports page of the software application. As shown in FIG. 15, the reports page 168 of the computer-based method 100 preferably includes: a logo 130; login status 132; logout button 134; dashboard button 136; subjects button 138; assessment button 140; reports button 142; users list button 144; roles button 146; department button 148; questions button 150; questions categories button 152; conflict origin button 154; actions button 156; regions button 158; and medical centers button 160. The reports page 168 also preferably provides conflict information regarding certain users and preferably includes search criteria, including: a date search field 505; assessment type search field 507; medical centers search field 509; region search field 511; department search field 513; question search field 515; user search field 517; run button 519; save report button 520; and report results 523. The date search field 505 preferably filters search results of multiple reports based upon a range of dates. The assessment type search field 507 preferably filters search results of multiple reports based upon a specific type of assessment. The medical centers search field 509 preferably filters search results of multiple reports based upon specific medical centers. The region search field 511 preferably filters search results of multiple reports based upon specific regions. The department search field 513 preferably filters search results of multiple reports based upon specific departments. The question search field 515 preferably filters search results of multiple reports based upon specific questions. The user search field 517 preferably filters search results of multiple reports based upon specific users. The run button 519 preferably executes the one or more search filters, and the save report button 520 preferably saves the search criteria.

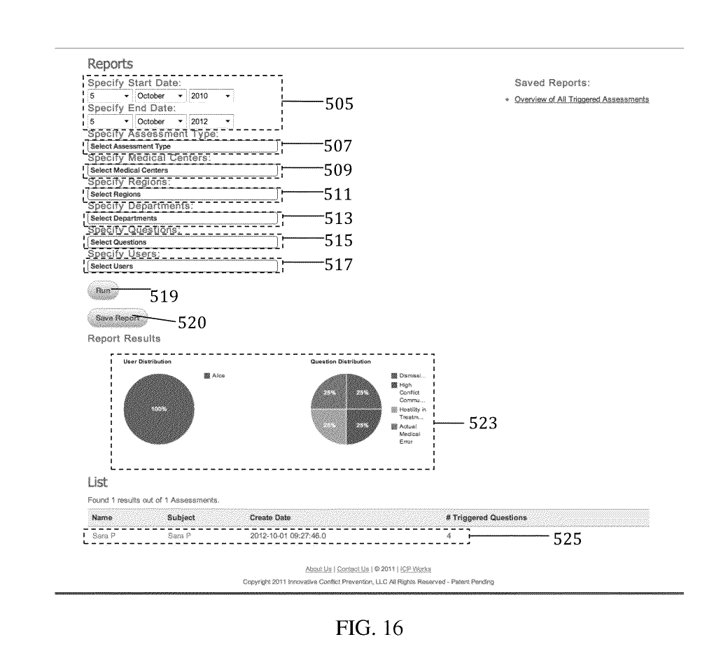

FIG. 16 is a screen shot of one embodiment of the computer-based method for managing conflict identification and shows the reports page with a graphical report. As shown in FIG. 16, the computer-based method 100 preferably includes: a date search field 505; assessment type search field 507; medical centers search field 509; region search field 511; department search field 513; question search field 515; user search field 517; run button 519; save report button 520; report results 523; and one or more assessments 525. FIG. 16 also shows that the report results 523 may include graphical depictions of conflicts, which may include pie graphs. Although FIG. 16 shows pie graphs as graphical results for a report, the present invention allows any type of graphical depictions including tables, columns, charts and the like. As discussed above, the assessments 525 are preferably surveys, observations, or evaluations regarding certain factors within an organization and are preferably related to the report results 523, as shown in FIG. 16.

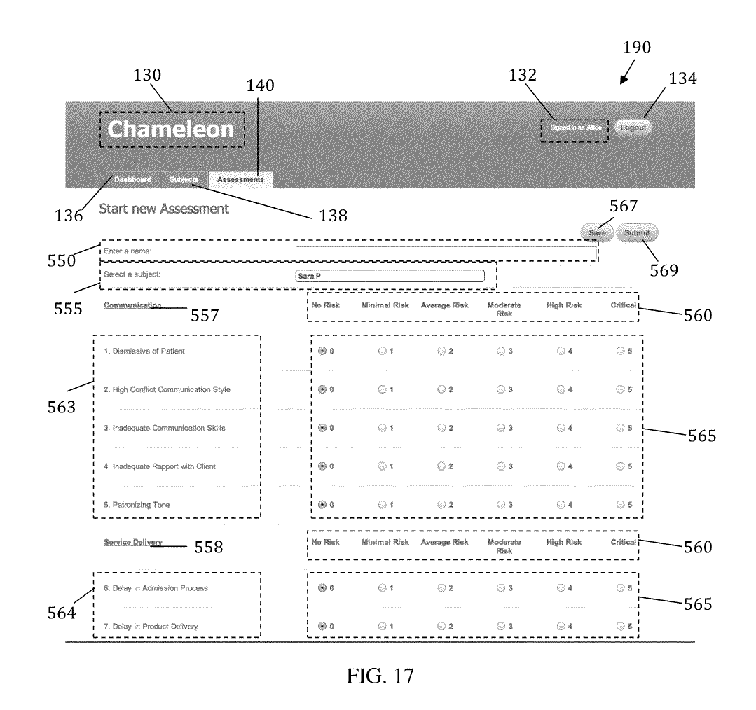

FIG. 17 is a screen shot of one embodiment of the computer-based method for managing conflict identification and shows the page of the software application for starting a new assessment. As shown in FIG. 17, the new assessment page 190 of the computer-based method 100 preferably includes: a logo 130; login status 132; logout button 134; dashboard button 136; subjects button 138; and assessment button 140. The new assessment page 190 typically contains one or more questions concerning conflicts and also preferably includes: a name input field 550; a subject input field 555; one or more question categories 557, 558; trigger level 560; a plurality of questions 563, 564; a plurality of risk level selections 565; save button 567; and submit button 569. The name input field 550 preferably allows the user to input a name of a particular assessment. The subject input field 555 preferably allows the user to select a particular user who is subject to the assessment 525. The question categories 557, 558 typically include a particular set of questions pertaining to a particular category. The questions 563, 564 preferably are the one or more questions utilized to assess certain conflicts. The trigger level 560 preferably depicts the trigger levels 560 or degree of conflict and may be measured on a scale or spectrum. The risk level selections 565 preferably provide the user with multiple choices to select the varying degrees of trigger levels 560. The save button 567 preferably allow the user to save his or her answer choices, and the submit button 569 preferably allows the user submit his or her trigger level selections.

FIG. 18 is a screen shot of one embodiment of the computer-based method for managing conflict identification and shows the dashboard page of the software application. As shown in FIG. 18, the dashboard page 162 of the computer-based method 100 preferably includes: a logo 130; login status 132; logout button 134; dashboard button 136; subjects button 138; and assessment button 140. The dashboard page 162 also preferably includes: one or more alerts 573 and one or more subjects 575. The alerts 573 preferably provide notification and information regarding subjects and assessments that typically require immediate attention. The subjects 575 are preferably users that completed the assessments.

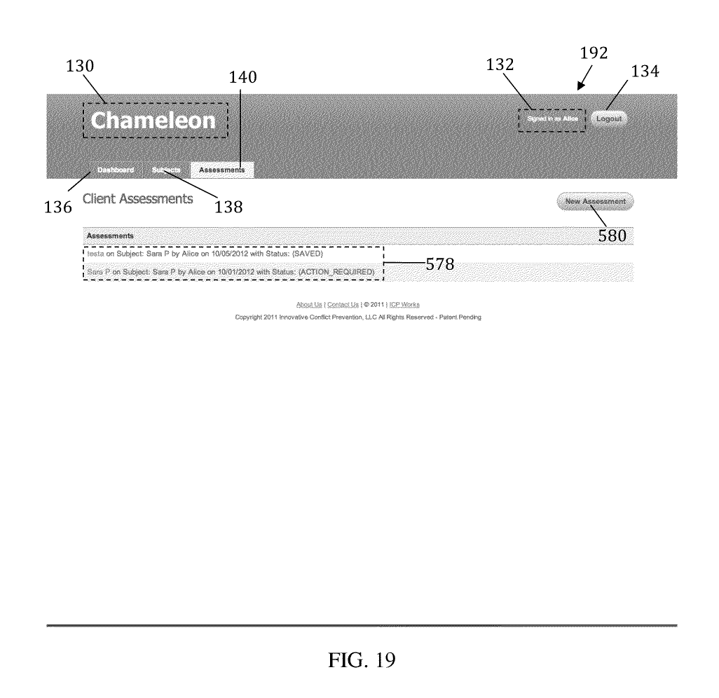

FIG. 19 is a screen shot of one embodiment of the computer-based method for managing conflict identification and shows the client assessments page of the software application. As shown in FIG. 19, the client assessments page 192 of the computer-based method 100 preferably includes: a logo 130; login status 132; logout button 134; dashboard button 136; subjects button 138; and assessment button 140. The client assessments page 192 also preferably includes one or more assessments 578 and a new assessment button 580. The assessments 578 are preferably sets of questions that have answered completely, saved, and/or submitted by a subject. The new assessment button 580 preferably provides the option for the administrative user to create a new assessment 525 for a particular subject or user. Preferably, the client assessments page 192 provides a list of assessments performed by users and may inform the administrative user the type of assessments that require immediate attention.

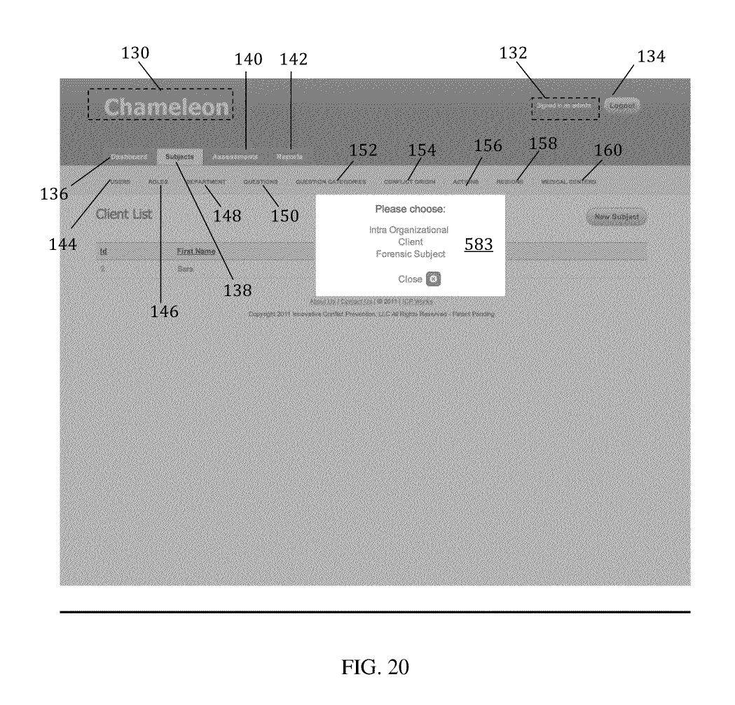

FIG. 20 is a screen shot of one embodiment of the computer-based method for managing conflict identification and shows the function for selecting different types of assessments. As shown in FIG. 20, the computer-based method 100 preferably includes: a logo 130; login status 132; logout button 134; dashboard button 136; subjects button 138; assessment button 140; reports button 142; users list button 144; roles button 146; department button 148; questions button 150; questions categories button 152; conflict origin button 154; actions button 156; regions button 158; and medical centers button 160. The computer based method also preferably includes the function 583 for selecting different types of assessments modules. For example, as shown in FIG. 20, function 583 preferably allows the administrator to select among three modules: intra-organizational subject, client subject, and forensic subject. Preferably, each module populates certain information (e.g., questions, question categories, former employee, former client, etc. . . . ) based upon the user's selection.

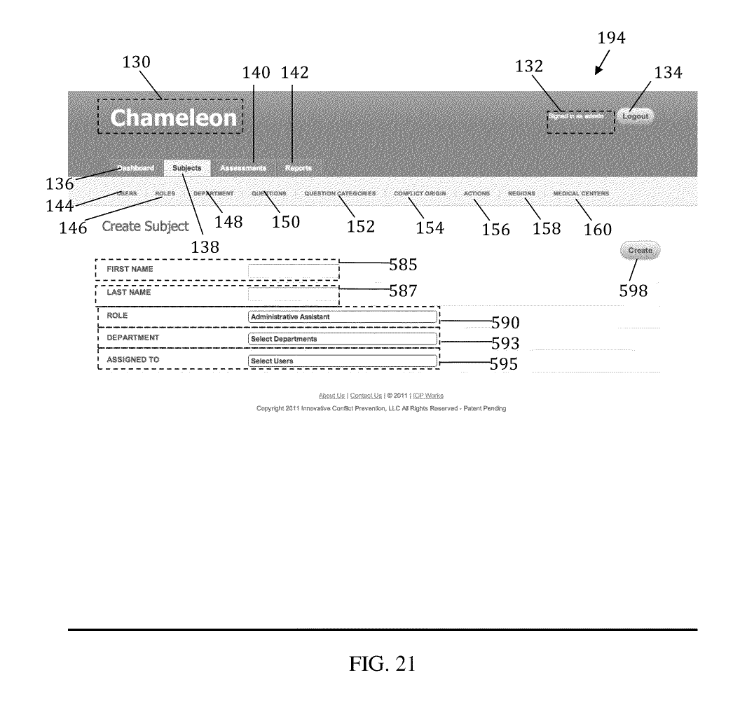

FIG. 21 is a screen shot of one embodiment of the computer-based method for managing conflict identification and shows the create subject page of the software application when populating on an intra-organizational subject. The create subject page 194 in FIG. 21 is preferably the page, which allows the creation of a certain subject, as it applies in an intra-organization setting. As shown in FIG. 21, the create subject page for an intra-organizational subject 194 of the computer-based method 100 preferably includes: a logo 130; login status 132; logout button 134; dashboard button 136; subjects button 138; assessment button 140; reports button 142; users list button 144; roles button 146; department button 148; questions button 150; questions categories button 152; conflict origin button 154; actions button 156; regions button 158; and medical centers button 160. The create subject page 194 also preferably includes: first name input field 585; last name input field 587; role select field 590; department select field 593; assign to field 595; and create button 598. The first name input field 585 preferably allows the administrative user to input the subject's first name. The last name input field 587 preferably allows the administrative user to input the subject's last name. The role select field 590 preferably allows the administrative user to select the subject's role in the organization. The department select field 593 preferably allows the administrative user to select the subject's department in the organization. The assign to field 595 preferably provides the option to assign the subject to selected users. The create button 598 preferably allows the administrative user to create a new subject as it applies to an intra-organizational subject.

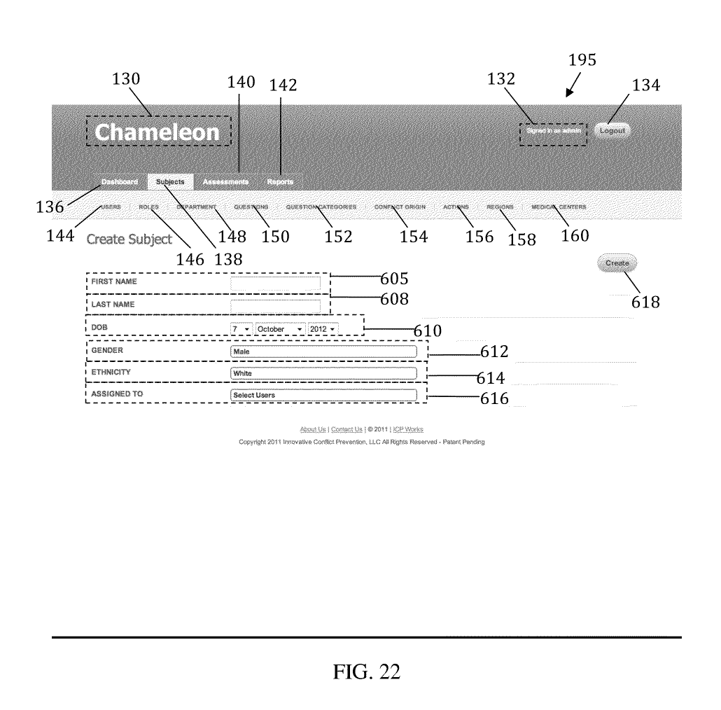

FIG. 22 is a screen shot of one embodiment of the computer-based method for managing conflict identification and shows the create subject page of the software application when populating on a client subject. The create subject page 195 in FIG. 22 is preferably the page, which allows the creation of a certain subject, as it applies to a client subject 195. As shown in FIG. 22, the create subject page for a client subject 195 of the computer-based method 100 preferably includes: a logo 130; login status 132; logout button 134; dashboard button 136; subjects button 138; assessment button 140; reports button 142; users list button 144; roles button 146; department button 148; questions button 150; questions categories button 152; conflict origin button 154; actions button 156; regions button 158; and medical centers button 160. The create subject page for a client subject 195 also preferably includes: first name input field 605; last name input field 608; date of birth select field 610; gender select field 612; ethnicity field 614; assign to field 616; and create button 618. The date of birth select field 610 preferably allows the administrative user to input the user's date of birth. The gender select field 612 preferably allows the administrative user to input the user's gender. The ethnicity field 614 preferably allows the administrative user to input the user's ethnicity (e.g., Caucasian, African American, Asian, Latino, etc. . . . ), and the create button 618 preferably allows the administrative user to create the subject as it applies to a client subject.

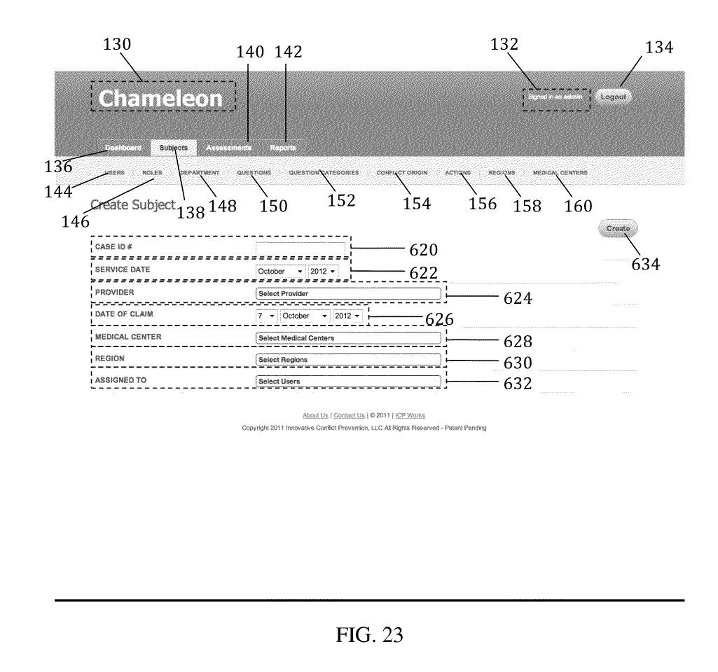

FIG. 23 is a screen shot of one embodiment of the computer-based method for managing conflict identification and shows the create subject page of the software application when populating on a forensic subject. Specifically, the create subject page 196 preferably allows the creation of a certain subject, as it applies previous case histories, which may consist of former client file information or a former employee file information. As shown in FIG. 23, the create subject page for a forensic subject 196 of the computer-based method 100 preferably includes: a logo 130; login status 132; logout button 134; dashboard button 136; subjects button 138; assessment button 140; reports button 142; users list button 144; roles button 146; department button 148; questions button 150; questions categories button 152; conflict origin button 154; actions button 156; regions button 158; and medical centers button 160. The create subject page for a forensic subject 196 also preferably includes: a case identification input field 620; service date input field 622; provider select field 624; date of claim field 626; medical center input field 628; region select field 630; assign to field 632; and create button 634. The case identification input field 620 preferably allows the administrative user to input the subject's case or identification number. The service date input field 622 preferably allows the administrative user to input the subject's date, in which a former assessment was performed or a particular case history. The provider select field 624 preferably allows the administrative user to select a particular organization or provider. The date of claim field 626 preferably allows the administrative user to input the date when a particular claim was made. The medical center input field 628 preferably allows the administrative user to select the medical center where a particular conflict arose. The region select field 630 preferably allows the administrative user to select a specific region where a particular claim was made. The assign to field 632 preferably allows the administrative user to assign the subject particular users, and the create button 634 preferably creates the desired subject, relating to a particular forensic subject 196.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A computer-based method for managing conflict identification, the steps comprising:
providing an electronic data processing unit and a server;
wherein said electronic data processing unit provides one or more users with one or more assessments;
inputting data into said one or more assessments by said one or more users to create one or more assessment data;
populating a database of said server with said one or more assessment data;
wherein said server includes one or more software applications;
analyzing said one or more assessment data by said one or more software applications to identify one or more conflicts; and
creating one or more alerts by said one or more software applications to notify one or more administrative users about said one or more conflicts.

2. The computer-based method of claim 1, wherein said one or more assessment data includes one or more questions and one or more trigger levels.

3. The computer-based method of claim 2, wherein said analyzing step further comprises the step of:
comparing said one or more trigger levels of said one or more questions with one or more risk factors;
wherein said one or more risk factors aid in recognizing said one or more conflicts.

4. The computer-based method of claim 1, wherein said one or more software applications further comprises of:
an administrative login; and
a standard user login;
wherein said administrative login provides said one or more administrative users with one or more administrative privileges; and
wherein said standard user login provides said one or more users with one or more standard privileges.

5. The computer-based method of claim 4, wherein said one or more administrative privileges is selected from the group consisting of: creating one or more user accounts for said one or more users; creating one or more questions of said one or more assessments; and accessing said one or more alerts.

6. The computer-based method of claim 4, wherein said one or more standard privileges includes performing said inputting step; and
wherein said inputting step is performed by selecting one or more risk level selections for one or more questions of said one or more assessments.

7. The computer-based method of claim 1, wherein said one or more software applications provide one or more conflict resolution actions to address said one or more conflicts.

8. The computer-based method of claim 1, further comprising the step of:
providing one or more reports of said one or more conflicts by said one or more software applications.

9. The computer-based method of claim 1, wherein said analyzing step further comprises the step of:
analyzing one or more previous case histories to aid in identifying said one or more conflicts.

10. The computer-based method of claim 1, wherein said one or more assessments are based upon the group consisting of: an intra-organizational subject; a client subject; and a forensic subject.

11. A computer-based method for managing conflict identification, the steps comprising:
providing an electronic data processing unit and a server;
wherein said electronic data processing unit provides one or more users with one or more assessments;
inputting data into said one or more assessments by said one or more users to create one or more assessment data;
populating a database of said server with said one or more assessment data;
wherein said server includes one or more software applications;
analyzing said one or more assessment data by said one or more software applications to identify one or more conflicts; and
creating one or more alerts by said one or more software applications to notify one or more administrative users about said one or more conflicts.

12. The computer-based method of claim 11, wherein said one or more assessment data includes one or more questions and one or more trigger levels.

13. The computer-based method of claim 12, wherein said analyzing step further comprises the step of:
comparing said one or more trigger levels of said one or more questions with one or more risk factors;
wherein said one or more risk factors aid in recognizing said one or more conflicts.

14. The computer-based method of claim 13, wherein said one or more software applications further comprises of:
an administrative login; and
a standard user login;
wherein said administrative login provides said one or more administrative users with one or more administrative privileges; and
wherein said standard user login provides said one or more users with one or more standard privileges.

15. The computer-based method of claim 15, wherein said one or more standard privileges includes performing said inputting step; and
wherein said inputting step is performed by selecting said one or more risk level selections for said one or more questions of said one or more assessments.

16. The computer-based method of claim 16, wherein said one or more software applications provide one or more conflict resolution actions to address said one or more conflicts.

17. The computer-based method of claim 17, further comprising the step of:
providing one or more reports of said one or more conflicts by said one or more software applications.

18. The computer-based method of claim 18, wherein said analyzing step further comprises the step of:
analyzing one or more previous case histories to aid in identifying said one or more conflicts.

19. The computer-based method of claim 19, wherein said one or more assessments are based upon the group consisting of: an intra-organizational subject; a client subject; and a forensic subject.

20. A computer-based method for managing conflict identification, the steps comprising:
providing an electronic data processing unit and a server;
wherein said electronic data processing unit provides one or more users with one or more assessments;
wherein said one or more assessments are based upon the group consisting of: an intra-organizational subject; a client subject; and a forensic subject;
inputting data into said one or more assessments by said one or more users to create one or more assessment data;
wherein said one or more assessment data includes one or more questions and one or more trigger levels;
populating a database of said server with said one or more assessment data;
wherein said server includes one or more software applications;
wherein said one or more software applications further comprises of: an administrative login and a standard user login;
wherein said administrative login provides said one or more administrative users with one or more administrative privileges;
wherein said standard user login provides said one or more users with one or more standard privileges, such that said one or more users perform said inputting step by selecting said one or more risk level selections for said one or more questions of said one or more assessments;
analyzing said one or more assessment data by said one or more software applications to identify one or more conflicts, such that said one or more software applications compare said one or more trigger levels of said one or more questions with one or more risk factors;
wherein said one or more risk factors aid in recognizing said one or more conflicts;
analyzing one or more previous case histories to aid in identifying said one or more conflicts;
creating one or more alerts by said one or more software applications to notify one or more administrative users about said one or more conflicts; and
providing one or more conflict resolution actions by said one or more software applications to address said one or more conflicts.
